(19) United States
(12) Patent Application Publication
(10) Pub. No.: US 2008/0081251 A1
(43) Pub. Date: Apr. 3, 2008

(54) THERMALLY DECOUPLING ENERGY STORAGE ELECTRODE CORE APPARATUS AND ARTICLE OF MANUFACTURE

(76) Inventor: John Miller, Cedar, MI (US)

Correspondence Address: MAXWELL TECHNOLOGIES, INC., 9244 BALBOA AVENUE, SAN DIEGO, CA, 92123, US

(21) Appl. No.: 11/536,980

(22) Filed: Sep. 29, 2006

(51) Int. Cl. H01M 4/02; H01M 4/58; H01G 4/38

(52) U.S. Cl. 429/128; 429/94; 429/231.8; 361/328

(57) ABSTRACT

An electrode core apparatus and article of manufacture adapted for use in an energy storage device are disclosed. In one embodiment, a thermally decoupling electrode core apparatus is disclosed. In another embodiment, a heat controlled electrode core is disclosed. In yet another embodiment, a thermally decoupling electrode core article of manufacture is disclosed. The electrode core of the present teachings function to optimize several energy storage device performance parameters simultaneously, such as for example thermal decoupling, reducing, undesirable electromagnetic effects such as current leakage and impedance issues.

### BACKGROUND

1. Field

The disclosed apparatuses and article of manufacture relates generally to energy storage devices, and particularly to increasing an energy storage device electrode core operational performance characteristic.

2. Related Art

Energy storage device element design is driven by a variety of parameters, such as for example thermal characteristics and electromagnetic problems (e.g., ESR, inductance). One of the most important elements of an energy storage device for optimal functioning is an electrode core. Key operational performance characteristics for energy storage device (e.g., ultracapacitor battery) electrode cores include, inter alia, thermal control and reduction of inductance effects.

A need exists to increase thermal performance of energy storage device elements, particularly within the electrode core. Also, design enhancement are needed in the area of thermal gradients within the energy storage device cell and cell-packs (multi-cell modules). Moreover, control of heat flow away from the electrode core is becoming more important, particularly as industry needs, such as for example electric automobiles, drives the commercial sector. Any advancement in the efficiency of thermal performance will increase the utility of an associated energy storage device. As industry usage of energy storage cell modules increases, such as for example in “hybrid” automobiles, the need to control thermal gradients in such modules is fast becoming evident. Also, usage of such cell modules in geographical regions which have relatively high ambient temperatures, would greatly, benefit from better energy storage device design emphasizing thermal considerations.

Also, a design issue with modern ultracapacitor cells is internal inductance, generated by the circumferential current flow about the “jelly-roll” inside the cell core. Such an inductance creates an undesirable impedance for an ultracapacitor electrode core, ultimately degrading performance, as will be appreciated by those of skill in the art. Any reduction in the amount of internal inductance within the electrode core would improve performance.

Moreover, as will be appreciated by those of ordinary skill in the energy storage device electrode core arts, inductance of ultracapacitor electrode cores causes damage to cell module balancers, due to over-voltage. Therefore, a need exists for a reduction in failure of energy storage device cell modules due to balancer damage,

Furthermore, modern cell construction techniques for ultracapacitors includes a core involute. The core involute contributes to sharp bend radii of an electrode core (contributing to “hot” spots in the electrode core), and possibly contributes to leakage current. Such hot spots and leakage current further degrade ultracapacitor performance.

Therefore, a need exists to improve thermal and electromagnetic performance of an energy storage device electrode core, as well as reducing problematic effects of a core involute. The present teachings provide solutions for the aforementioned issues.

### SUMMARY

In one embodiment of the present teachings, a thermal decoupling energy storage electrode core, adapted for use in an energy storage device, is disclosed. The electrode core comprises a first current collector foil element having a first side and a second side, comprising, (i) a first plurality of carbon electrode elements disposed on the first side of the first current collector foil element, (ii) a second plurality of carbon electrode elements disposed on the second side of the first current collector foil element, and (iii) a first plurality of fold zone regions defined between a first plurality of fold zone demarcation regions. The thermally decoupling energy storage electrode core further comprises a separator element, having a front side and a back side, wherein the separator element front side is affixed to the second side of the first current collector foil element. Moreover, the electrode core of the present disclosure further comprises a second current collector foil element having a top side and a bottom side, wherein the second current collector foil element top side is affixed to the separator element back side, the second current collector foil element comprising (i) a third plurality, of carbon electrode elements disposed on the top side of the second current collector foil element, (ii) a fourth plurality of carbon electrode elements disposed on the bottom side of the second current collector foil element, and (iii) a second plurality of fold zone regions defined between a second plurality of fold zone demarcation regions.

In another embodiment of the present teachings, a heat controlled electrode core, adapted for use in an energy storage device, is disclosed. The heat controlled electrode core comprises a first current collector foil element having a first side and a second side, comprising (i) a first plurality of fold zone regions defined between a first plurality of fold zone demarcation regions. The heat controlled electrode core further comprises a separator element, having a front side and a back side, wherein the separator element front side is affixed to the second side of the first current collector foil element. The heat controlled electrode core further comprises a second current collector foil element having a top side and a bottom side, wherein the second current collector foil element top side is affixed to the separator element back side, the second current collector foil element comprising, (i) a second plurality of fold zone regions defined between a second plurality of fold zone demarcation regions.

In one embodiment of the present teachings, a thermally decoupling electrode core article of manufacture adapted for use in a hybrid energy storage device is disclosed. The article of manufacture comprises a first current collector foil element having a first side and a second side, comprising, (i) a first plurality of carbon electrode elements disposed on the first side of the first current collector foil element, (ii) a second plurality of carbon electrode elements disposed on the second side of the first current collector foil element and (iii) a first plurality of fold zone regions defined between a first plurality of fold zone demarcation regions. The article of manufacture further comprises a separator element having a front side and a back side wherein the separator element front side is affixed to the second side of the first current collector foil element. The article of manufacture further comprises a second current collector foil element having a top side and a bottom side, wherein the second current collector foil element top side is affixed to the separator element back side, the second current collector foil element comprises (i) a third plurality of carbon electrode elements disposed on the top side of the second current collector foil element, (i) a fourth plurality of carbon electrode elements disposed on the bottom side of the second current collector foil element, and (iii) a second plurality of fold zone regions defined between a second plurality of fold zone demarcation regions.

### BRIEF DESCRIPTION OF THE DRAWINGS

Embodiments of the disclosed method and apparatus will be more readily understood by reference to the following figures, in which like reference numbers and destination indicate like elements.

FIG. 1a illustrates a front plan view of a current collector foil having a plurality of carbon electrode elements and a plurality of fold zone regions defined between a plurality of demarcation regions, according to one embodiment of the present teachings.

FIG. 1b illustrates a front plan view of a separator element, according to one embodiment of the present teachings.

FIG. 2 illustrates a perspective view of an electrode core element, according to one embodiment of the present disclosure.

FIG. 3 illustrates a perspective view of an electrode core, according to one embodiment of the present teachings.

FIG. 4 illustrates a perspective view of a localized region of an electrode core, according to one embodiment of the present disclosure.

### DETAILED DESCRIPTION

### Overview

The present teachings disclose an apparatus and article of manufacture for optimizing energy storage electrode core performance. In some embodiments undesirable inductance is addressed and reduced to enhance electrode core performance. In other embodiments undesirable thermal heat flow within an electrode core is addressed and reduced to enhance electrode core performance,

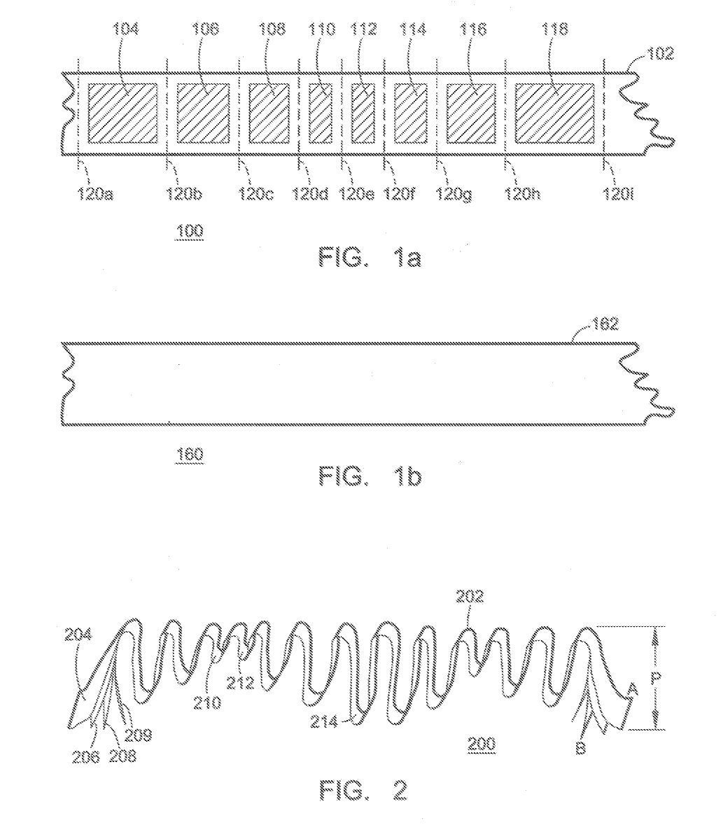

Referring flow to FIG. 1a-b, one illustrative exemplary embodiment of an energy storage electrode 100 is shown. In one embodiment, the energy storage electrode 100 comprises a thermally decoupling energy storage electrode core, comprising a first current collector foil element 102, a separator element 162, and a second current collector foil element (not shown). In some embodiments of the present teachings, the second current collector foil element is identical to the first current collector foil element 102. In one alternate embodiment of the present disclosure, the energy storage electrode 100 comprises a heat controlled electrode core, adapted for use in an energy storage device, comprising a first current collector foil element 102, a separator element 162, and a second current collector foil element (not shown). In some embodiments of the present teachings, the second current collector foil element is identical to the first current collector foil element 102. In one embodiment, the energy storage device is an ultracapacitor, however the present teachings may readily be adapted for use in a lithium ion battery, hybrid energy storage devices, or literally any type of energy storage device which requires an electrode core,

In one embodiment, the first current collector foil element 102 is composed of, inter alia, aluminium. FIG. 1a illustrates how electrode material, such as for example carbon, is disposed upon both sides of a double-sided current collector foil. In one embodiments carbon electrode elements 104, 106, 108, 110, 112, 114, 116, and 118 are disposed along a first side of the first current collector foil element 102. Also illustrated in FIG. 1a l is a modulation of electrode width such that the progressively thinner spans of carbon can be folded back upon itself in the final configuration, as will be described further below. The carbon electrode elements 104, 106, 108, 110, 112, 114, 116 and 118 follow a pulse-width-modulation type of pattern, however literally any kind of shape modulation pattern of the carbon electrode elements 104, 106, 108, 110, 112, 114, 116, and 118 is within the scope of the present teachings, such as for example amplitude and/or phase modulated patterns.

In one embodiment, a plurality of carbon electrode elements 104, 106, 108, 110, 112, 114, 116, and 118 are disposed upon both sides of the current collector foil 102. It will be appreciated that only one side of the double-sided current collector foil 102 is illustrated in FIG. 1a. Moreover, the plurality of carbon electrode elements 104, 106, 108, 110, 112, 114, 116, and 118 each have an identical matched pair respectively disposed on another side of the double-sided current collector foil 102 (not shown). In other words, carbon electrode elements are disposed in a modulated pattern on both sides of the double-sided current collector foil 102 in a similar fashion.

Each of the plurality, of carbon electrode elements 104, 106, 108, 110, 112, 114, 116, and 118 is bounded by a plurality of fold zone regions defined between a plurality of fold zone demarcation regions 120a, 120b, 120c, 120d, 120e, 120f, 120g, 120h, and 120i, as illustrated in FIG. 1a. In other words, a first fold zone region is defined between fold zone demarcation regions 120a and 120b whereas a second fold zone region is defined between fold zone demarcation regions 120b and 120c. Additional fold zones are similarly defined.

FIG. 1b illustrates a front plan view of a separator element 162, having a front side and a back side. The separator element 162 has dimensions of length and width approximately identical to the first current collector foil element 102 described above. In the completed assembly of the radii modulated annular electrode core apparatus, the separator 100 is interposed between the first current collector foil element 102 and a second current collector foil element, as will be described further below. The separator 162 functions to prevent the first current collector foil element 102 from electronically shorting to the second current collector foil, while simultaneously allowing ionic current to flow therebetween.

FIG. 2 illustrates one exemplary embodiment of a perspective view of an annular electrode core element 200 adapted for use in an energy storage device. The annular electrode core element 200 generally comprises a first current collector foil element 204, a first separator element 206, a second current collector foil element 208, and a second separator element 209.

In one exemplary embodiment, the annular electrode core element 200 comprises a radii modulated annular electrode core. In this embodiment, the first current collector element 204 of width “W”, the first separator element 206, the second current collector foil element 208 of width “W”, and the second separator element 209 are layered and folded (collapsed) along the plurality of fold zone demarcation regions 120a, 120b, 120c, 120d, 120e, 120f, 120g, 120h, and 120i as described above with reference to FIG. 1a. The two current collector foils 204 and 208 are displaced axially such that one foil side “A” overhangs a separator element while the opposite foil side “B” overhangs the separator diametrically opposed to “A”.

The annular electrode core element 200, when folded along the fold zone demarcation regions, collapses into a structure having a continuous gradation of fold peaks. The peak amplitude “P”, as shown in FIG. 2, of the folds is selected so that the outer folds define an outside radius, and a plurality of intermittently disposed inner peaks define an inside radius of a final electrode core assembly, as will be described further below. A length of the outside radius corresponds to a relatively large amplitude fold 214, whereas the inside radius corresponds to a relatively small amplitude fold, 210 and/or 212. In one embodiment, the annular core element 200 is adapted for use as a heat controlled electrode core, wherein the relatively small amplitude folds function as thermal via, facilitating heat removal from the electrode core.

It will be appreciated that the relative amplitude of each fold zone is determined by the width of the plurality of carbon electrode elements 104, 106, 108, 110, 112, 114, 116, and 118, as described above with respect to FIG. 1a. In one exemplary embodiment, the small amplitude fold 212 corresponds to the small width of the carbon electrode element 110 of FIG. 1a, whereas the large amplitude fold 214 corresponds to the large width of the carbon electrode element 118 of FIG. 1a.

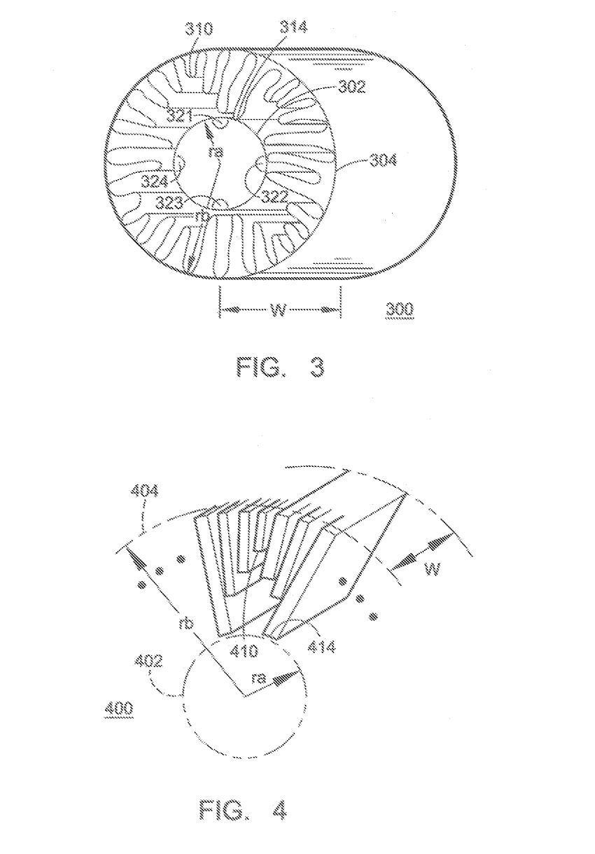

When folded (collapsed), the plurality of carbon electrode elements 104, 106, 108, 110, 112, 114, 116, and 118 are relatively flat in localized regions between the folds, as will be described further below with respect to FIGS. 3 and 4 in embodiments where an energy storage device electrode core is formed into an annular electrode core. Because tight foil radii are restricted to only inner and outer edges of the annular electrode core element 200 heat dissipation is maximized. Moreover the “fan-fold” structure readily lends itself to a hollow cored structure (as will be described further below in greater detail), in which an inner passage is available for heat removal from an energy storage device electrode cell core.

FIG. 3 illustrates a perspective view of an electrode core 300, according to one embodiment of the present teachings. In one embodiment the electrode core 300 comprises a plurality of fold peaks 321, 322, 323 and 374, an inner radius (“rₐ”) 302, and an outer radius (“r_{b}”) 304. In the illustrative exemplary embodiment of FIG. 3, an integral number of peaks (“Np”) (e.g., the plurality of fold peaks 321, 322, 323, and 324) are oriented about the center of the electrode core 300, as will be described further below.

In one embodiment, the annular electrode core element 200 of FIG. 2 is compressed (or wrapped) into a circumferentially oriented “accordion-type” shape, in order to achieve the electrode core 300 of FIG. 3. In this embodiment, the electrode core 300 is compressed circumferentially so that an integral number of peaks Np is four (i.e., the plurality of fold peaks 321, 322, 323 and 324). In this configuration of the electrode core 300, a plurality of densely packed electrode carbon powder patches (not shown) are kept flat along radial lines of a final assembly of the present teachings. Once compressed circumferentially the carbon electrode patches fill the annular region (defined in a region between rₐ and r_{b}) without loss of active volume, because the presently disclosed teachings provide a Pulse-Width-Modulation (“PWM”) pattern with a sufficient number of steps Nₛ between rₐ and r_{b}.

When assembled, the electrode core 300 permits a different type of conductive pathway for current flow, relative to prior art methods. In prior art solutions, the normal pathway for current flow in an energy storage device has been along a circumferential axis, around the wound electrode core. Such a pathway contributes to inductive impedance (due to such a long current path) and reduces overall performance by increasing equivalent series resistance and reducing overall efficiency of the energy storage device. By contrast, in the present disclosure, a significant advancement in these problems is achieved because a longitudinal conductive pathway, along a longitudinal axis of an energy, storage device, is employed, thereby eliminating the circumferential current path. Therefore, the present disclosure provides a significantly shorter current path, therefore less inductive impedance and greater overall efficiency of the energy storage device, increased longevity, and reducing equivalent series resistance.

FIG. 4 illustrates a perspective view of a localized region of an annular electrode core 400, according to one embodiment of the present disclosure. FIG. 4 highlights how a plurality of carbon patch areas (e.g., 410 and 414) accumulate to form pie shaped zones (“thermal vias”) such that an entire volume of an annular ring is filled. In this embodiment, the active portions of the carbon electrodes completely fill an annular region and the carbon electrode deposits are approximately flat. In one embodiment, an amount of carbon particle binder material required is reduced, because a resulting electrode matrix will not be exposed to physical tension, such as is found in current so-called “jelly-roll” configurations for energy storage devices, particularly at the core involute.

In one embodiment, the annular electrode core 400 is adapted to improve energy storage device cell thermal performance, by eliminating the jelly-roll involute. Additionally, this embodiment facilitates approximately complete parallel plate electrode operation, thereby allowing for use of lower tensile strength matrix binders for the carbon powder used for such devices.

In some embodiments of the present teachings, a sinusoidal modulation fold pattern is employed for the annular electrode core. To describe these embodiments, each “fold” generally begins at an outer radius r₀ and progressively decreases in radius with each successive fold, until an inner radius rᵢ₀ is reached, as will now be described in greater detail. In one embodiment, r₀ is equal to r_{b} and rᵢ₀ is equal to rₐ as described above with respect to FIGS. 3 and 4. Calculation of the relative radical length changes for each successive fold will now be disclosed.

In order to determine a relative radial length for each successive fold in an annular core electrode, the famous “golden ratio” is employed. The golden ratio expresses the relationship that the sum of two quantities is to the larger quantity as the larger is to the smaller. The golden ratio is an irrational number as expressed in EQUATION 1. In some embodiments of the present disclosure, the golden ratio is used as a starting point for initial sizing for the radii amplitudes peak-to-peak, as will now be described.

$$EQUATION 1 \text{:}$$

$$Ψ = \frac{\sqrt{5} - 1}{2}$$

Ψ=0.618

Also, note that using the golden ratio as a starting point that:

$$EQUATION 2 \text{:}$$

$${Ψ}_{r} = ( \frac{1}{Ψ} - 1 ) ;$$

$${Ψ}_{r} = 0.618$$

Define a number of folds “N” over a half period of radii modulation pattern:

N=20; K=1 . . . N

Now, in one embodiment:

r₀=30 mm; initial outer radius for the annular package;

Then let the maximum excursion of rᵢ(θ)−0.85 r₀ which results in:

$$EQUATION 3 \text{:}$$

$${r}_{i 0} = ( 1 - Ψ ) \cdot \frac{{r}_{0}}{2} ;$$

$${r}_{i 0} = 5.729 mm ,$$

inner radius starting point on magnitude

rₚₚ=0.85r₀=rᵢ₀; rₚₚ=19.771 mm peak-to-peak variation

In one embodiment a modulated radii composite function is calculated according to EQUATION 4, and the relative radial lengths are shown in GRAPH 1, as shown below.

$$EQUATION 4 \text{:}$$

$${r}_{i} ( k ) = \frac{{r}_{pp}}{2} \cdot sin ( \frac{2 k \cdot π}{N} ) + {r}_{i 0} + \frac{{r}_{pp}}{2} mm$$

The actual fold pattern lengths are then rᵢ₀−rᵢ(k).

Now calculating the actual fold lengths (such as for example to calculate the active carbon electrode sectional area) would be the function (r₀−rᵢ(k)) which is plotted below in GRAPH 2.

In one embodiment, an integral number of “circles” around the annular volume is calculated, such as for example in a 3N pattern the final pattern is shown by GRAPH 3:

In this embodiment, N=60, for three full cycles, each of the same number of folds per cycle as above.

The presently disclosed energy storage device electrode core embodiments are a significant progression on modern design techniques. The present teachings eliminate the need for a core involute and leave the electrode core hollow for other uses, such as for example evacuation of heat from a cell (such as for example using liquid, air, etc. . . . ) Also, because foil edges of the electrode are, in some embodiments, only present at the inner and outer radii, means that thermal conduction is enhanced (i.e., no carbon layer intervenes), and heat removal is faster and more efficient. Such thermal benefits of the present teachings contribute to increased energy storage device cell longevity and overall performance because the cell has more efficient operation, hence less heat generated, more rapid beat removal (hence more efficient cooling), and the cell can operate at higher temperatures without failure.

In one embodiment, heat is routed directly to one or more endcaps of an energy storage device. Such routing facilitates cooling and eliminates and/or reduces thermal gradients inside the energy storage device. Therefore individual energy cells, and/or cell modules, are capable of being pushed to higher thermal limits than previously proposed solutions.

Moreover, substantial reduction in equivalent series resistance is achieved by the present disclosure, over prior art solutions, because current flows along a longitudinal axis of an energy storage device electrode core, thereby eliminating the previous circumferential current path about the electrode core. The equivalent series resistance is reduced, because inductive impedance is reduced, due to the shortened conductive pathway along which the current must travel within the electrode core.

### Conclusion

The foregoing description illustrates exemplary implementations, and novel features, of aspects of an apparatus and article of manufacture for effectively providing an energy storage electrode core. Given the wide scope of potential applications, and the flexibility inherent in electro-mechanical design, it is impractical to list all alternative implementations of the method and apparatus. Therefore, the scope of the presented disclosure should be determined only by reference to the appended claims, and is not limited by features illustrated or described herein except insofar as such limitation is recited in an appended claim.

While the above description has pointed out novel features of the present teachings as applied to various embodiments, the skilled person will understand that various omissions substitutions, permutations, and changes in the form and details of the methods and apparatus illustrated may be made without departing from the scope of the disclosure. These and other variations constitute embodiments of the described methods and apparatus.

Each practical and novel combination of the elements and alternatives described hereinabove, and each practical combination of equivalents to such elements, is contemplated as an embodiments of the present disclosure. Because many more element combinations are contemplated as embodiments of the disclosure than can reasonably be explicitly enumerated herein, the scope of the disclosure is properly defined by the appended claims rather than by the foregoing description. All variations coming within the meaning and range of equivalency of the various claim elements are embraced within the scope of the corresponding claim. Each claim set forth below is intended to encompass any system or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art.

What is claimed is:

1. A thermally decoupling energy storage electrode core, adapted for use in an energy storage device comprising:
a) a first current collector foil element having a first side and a second side, comprising:
i) a first plurality of carbon electrode elements disposed on the first side of the first current collector foil element;
ii) a second plurality of carbon electrode elements disposed on the second side of the first current collector foil element;
iii) a first plurality of fold zone regions defined between a first plurality of fold zone demarcation regions;
b) a separator element, having a front side and a back side, wherein the separator element front side is affixed to the second side of the first current collector foil element;
c) a second current collector foil element having a top side and a bottom side, wherein the second current collector foil element top side is affixed to the separator element back side, the second current collector foil element comprising:
i) a third plurality of carbon electrode elements disposed on the top side of the second current collector foil element;
ii) a fourth plurality of carbon electrode elements disposed on the bottom side of the second current collector foil element;
iii) a second plurality of fold zone regions defined between a second plurality of fold zone demarcation regions.

2. The thermally decoupling, energy storage electrode core of claim 1, further adapted to be collapsed along the first and second pluralities of fold zone demarcation regions into an approximately annular form, oriented along, a circumferential axis, wherein the first and second pluralities of fold zone demarcation regions are approximately laterally co-axially aligned with respect to the first and second current collector foils, thereby forming a collapsed thermally decoupling electrode core element.

3. The thermally decoupling energy storage electrode core of claim 2, wherein the a collapsed thermally decoupling electrode core element further comprises an approximately hollow core region.

4. The thermally decoupling energy storage electrode core of claim 3, further adapted to thermally conduct heat flow away from the energy storage device.

5. The thermally decoupling energy storage electrode core of claim 4, wherein the thermally conducted heat flow away from the energy storage device is facilitated via the approximately hollow core region.

6. The thermally decoupling energy storage electrode core of claim 5, further adapted to have an approximately axial current flow, which is approximately co-axial with a Z-axis of the radii modulated annular electrode core element.

7. The thermally decoupling energy storage electrode core of claim 6, wherein the energy storage device is further adapted to have a low profile.

8. A heat controlled electrode core, adapted for use in an energy storage device, comprising:
a) a first current collector foil element having a first side and a second side, comprising:
i) a first plurality of fold zone regions defined between a first plurality of fold zone demarcation regions;
b) a separator element, having a front side and a back side, wherein the separator element front side is affixed to the second side of the first current collector foil element;
c) a second current collector foil element having a top side and a bottom side, wherein the second current collector foil element top side is affixed to the separator element back side, the second current collector foil element comprising:
i) a second plurality of fold zone regions defined between a second plurality of fold zone demarcation regions.

9. The heat controlled electrode core of claim 8, further adapted to be collapsed along the first and second pluralities of fold zone demarcation regions into an approximately annular form, oriented along a circumferential axis, wherein the first and second pluralities of fold zone demarcation regions are approximately laterally co-axially aligned with respect to the first and second current collector foils, thereby forming a collapsed heat controlled annular electrode core.

10. The heat controlled electrode core of claim 9, wherein the collapsed heat controlled annular electrode core further comprises an approximately hollow core region.

11. The heat controlled electrode core of claim 10, further adapted to thermally conduct heat flow away from the energy storage device.

12. The heat controlled electrode core of claim 11, wherein the thermally conducted heat flow away, from the energy storage device is facilitated via the approximately hollow core region.

13. The heat controlled electrode core of claim 12, further adapted to have an approximately axial current flow, which is approximately co-axial with a Z-axis of the heat controlled electrode core.

14. The heat controlled electrode core of claim 13, wherein the energy storage device is further adapted to have a low vertical profile.

15. A thermally decoupling electrode core article of manufacture, adapted for use in a hybrid energy storage device, comprising:
a) a first current collector foil element having a first side and a second side, comprising:
i) a first plurality of carbon electrode elements disposed on the first side of the first current collector foil element;
ii) a second plurality of carbon electrode elements disposed on the second side of the first current collector foil element;
iii) a first plurality of fold zone regions defined between a first plurality of fold zone demarcation regions;
b) a separator element, having a front side and a back side, wherein the separator element front side is affixed to the second side of the first current collector foil element;
c) a second current collector foil element having a top side and a bottom side, wherein the so second current collector foil element top side is affixed to the separator element back side, the second current collector foil element comprising:
i) a third plurality of carbon electrode elements disposed on the top side of the second current collector foil element;
ii) a fourth plurality of carbon electrode elements disposed on the bottom side of the second current collector foil element;
iii) a second plurality of fold zone regions defined between a second plurality of fold zone demarcation regions.

16. The thermally decoupling electrode core article of manufacture of claim 15, further adapted to be collapsed along the first and second pluralities of fold zone demarcation regions into an approximately annular form, oriented along a circumferential axis wherein the first and second pluralities of fold zone demarcation regions are approximately laterally co-axially aligned with respect to the first and second current collector foils, thereby forming a collapsed thermally decoupling electrode annular core.

17. The thermally decoupling electrode core article of manufacture of claim 16, wherein the collapsed modulated electrode annular core further comprises an approximately hollow core

18. The thermally decoupling electrode core article of manufacture of claim 17, further adapted to thermally conduct heat flow away from the hybrid energy device.

19. The thermally decoupling electrode core article of manufacture of claim 18, wherein the thermally conducted heat flow away from the hybrid energy storage device is facilitated via the approximately hollow core region.

20. The thermally decoupling electrode core article of manufacture of claim 19, further adapted to have an approximately axial current flow, which is approximately co-axial with a Z-axis of the thermally decoupling electrode core article of manufacture.
